(19) United States
(12) Patent Application Publication
(10) Pub. No.: US 2006/0175097 A1
(43) Pub. Date: Aug. 10, 2006

(54) WIRELESS WEIGHING SYSTEM FOR A BED

(76) Inventor: Shazad Pirzada, Manhasset, NY (US)

Correspondence Address: WILLIAM COLLARD;COLLARD & ROE, P.C., 1077 NORTHERN BOULEVARD, ROSLYN, NY, 11576, US

(21) Appl. No.: 11/164,655

(22) Filed: Nov. 30, 2005

Related U.S. Application Data
(63) Continuation-in-part of application No. 10/939,816, filed on Sep. 13, 2004.
(63) Continuation-in-part of application No. PCT/US05/32758, filed on Sep. 13, 2005.
(60) Provisional application No. 60/631,841, filed on Nov. 30, 2004.

(51) Int. Cl. G01G 19/00

(52) U.S. Cl. 177/145

(57) ABSTRACT

A portable patient management system, which can be used to monitor the particular health characteristics of a patient. This device can include a central housing, a pump disposed in the central housing and at least one display disposed in the central housing. To control this pump there is at least one processor disposed in the central housing. This processor is in communication with the pump and the display. There is also at least one memory unit disposed in the central housing. This memory unit can contain a plurality of instructions to control the processor. There is also at least one communication element disposed in the central housing. The communication element allows the central housing to communicate with other components.

### CROSS REFERENCE TO RELATED APPLICATIONS

This application is a non-provisional application and claims the benefit of U.S. Provisional Application Ser. No. 60/631,841, filed on Nov. 30, 2005, the disclosure of which is hereby incorporated herein by reference. This application is a continuation in part application of U.S. patent application Ser. No. 10/939,816 filed on Sep. 13, 2004; this application is also a continuation in part application of International Application PCT/US2005/032758 filed on Sep. 13, 2005, which claims priority from U.S. patent application Ser. No. 10/939,816 filed on Sep. 13, 2004 and which claims priority from Provisional Application Ser. No. 60/631,841 filed on Nov. 30, 2005.

### BACKGROUND OF THE INVENTION

The invention relates to a pump which can be used to provide support for a bed. This pump is in the form of a portable pump that can be in the form of a wireless pump. In addition the invention can also relate to a remote weighing system that can be integrated with a pump or used with a control unit. The device can be used with a central patient management system for activating or deactivating a pump based upon a weight registered by the remote weighing system.

The weighing system can include a strain gauge system. Strain gauge systems are known in the art. For example, the following U.S. Patents relate to weighing systems: U.S. Pat. No. 4,036,318 to Nyholm issued on Jul. 19, 1977; U.S. Pat. No. 3,439,524 to Rogers issued on Apr. 22, 1969; U.S. Pat. No. 4,600,067 to Artigue et al issued on Jul. 15, 1986; U.S. Pat. No. 6,725,165 to Knox et al issued on Apr. 20, 2004; U.S. Pat. No. 5,962,792 to Kimerer Jr issued on Oct. 5, 1999; U.S. Pat. No. 3,986,012 to Loshbough et al issued on Oct. 12, 1976; U.S. Pat. No. 3,151,306 to Hines issued on Sep. 29, 1964; U.S. Pat. No. 3,665,169 to Henderson et al issued on May 23, 1972; U.S. Pat. No. 3,770,069 to Loshbough issued on Nov. 6, 1973; U.S. Pat. No. 3,777,828 to Dietmeyer issued on Dec. 11, 1973; U.S. Pat. No. 2,597,751 to Ruge issued on May 20, 1952; U.S. Pat. No. 3,869,004 to Gallo issued on Mar. 4, 1975; U.S. Pat. No. 3,742,329 to Giguere issued on Jun. 26, 1973 wherein the disclosures of all of these references are hereby incorporated herein by reference.

### SUMMARY OF THE INVENTION

The invention relates to a portable patient management system which can be used to monitor the particular health characteristics of a patient. This device can include a central housing, a pump disposed in the central housing and at least one display disposed in the central housing.

To control this pump, there is at least one processor disposed in the central housing. This processor is in communication with the pump and the display.

There is also at least one memory unit disposed in the central housing. This memory unit can contain a plurality of instructions to control the processor. There is also at least one communication element disposed in the central housing. The communication element allows the central housing to communicate with other components.

The other components can include a remote scale, having its own housing and a remote communication element stored in housing, this remote communication element can be for communicating with the at least one communication element, to transmit a weight measurement to the central measurement device.

The pump can be used with a wireless weight scale system. Alternatively a control unit without a pump can be used as well. Essentially in these systems, there can be two basic components, a weight scale and a display. In this case, the item being weighed, such as a bed is placed in the weight scale. Next, it generates a signal based upon the weight of the item. This signal is then changed to a telemetry signal so that it can be transmitted wirelessly. The display unit, which can include the pump, reads the signal and then converts it so that it can be read by the user.

The display is capable of reading signals from multiple weight scales and it can be used for either displaying individual scale weights or summing the weights. When using multiple weight scales, the weight distribution can be calculated by the display unit. Additionally since the weight is really read as a force (mass x gravity) this system can be used as a remote reader for a force gauge.

The uses for this type of a scale can be widely ranged. For example, it can be used in any application that requires the weighing of an item. By using this system with a single weighing scale, this system then has the advantage of allowing the user to place the display where it can be read easily and safely. For example, this system can be used as a personal scale wherein the display unit can be placed close to either a user or a caregiver.

For example, some of the uses for this scale could be for a personal scale, a doctor's scale, a shipping scale, a truck scale, a hoist scale, or for weighing applications in chambers.

The applications that can be used for multiple weight scale units, could include hospital beds, with non ambulatory patients, wheel chairs, or portable vehicle scales including automobiles, airplanes, motorcycles, and trailers.

The applications that could use the system for a force reading could include a drawbar force, a drag measurement or a tension measurement.

In one application, there can be four load cell modules for a hospital bed or a wheelchair. Each load cell module has a weighing pad for each receiving a wheelchair wheel or a bed leg which is placed on top of this load cell. This weighing pad is attached to a pair of load cells that bend under the weight of the item placed on it. In addition, a strain gauge is fixed to this load cell which changes its electrical resistance as a result of the response to the bending in the load cell. A printed circuit board which can be in the form of a transmitter board, reads the resistance of the two strain gauges, sums the two strain gauge readings and then sends this information to the control module via a ultra high frequency transmission. In addition to the weight, the transmitter board also sends information on the battery condition to the control module to warn the user of a low battery condition.

The control module receives information from the four load cell modules, sums up the four weight readings, converts the readings to a weight and then displays in real time weight and stores the weight data. It also monitors the condition of the batteries in each of the load cell modules. The control module will download the weight data to a handheld computer, personal digital assistant (pda), printer or any other enabled communication device such as a wireless or infrared or IrDA protocol or through bluetooth communication.

This design can be re-configured to use one or multiple load cell or strain gauges for other applications. If one was using a hoist weighing system, then only one load cell module would be required. However if the application is for weighing highway trucks, up to 12 load cell modules may be required with one control module.

With the case of a wireless weight scale system for a hospital bed or any other type of bed, the system includes load cells, which communicate with a control board using an RF channel. Thus, in this case a system can include a control module and 4 load cell modules.

In this case, the control module can function as the primary user interface which can be associated with a pump. This user interface can be associated with a portable pump.

The load cell modules can be placed under each leg of a bed and then these load cells measure the weight and transmit the weight and battery status to the control board. Each load cell board includes batteries, an RF transmitter, and a push button.

In the control module, the IrDA transceiver can be used to provide a data connection between the control board and a PDA. In this case, the control board can support any known protocol but this protocol can be in the form of a baud rate of 9600 bps. Alternatively, a bluetooth transceiver can be used as well.

In this case, the system can offer numerous features such as the ability to display the total weight, a manual zeroing of the displayed weight, to allow the displaying of a patient weight not including the bed weight, the selection of different weighing units such as lbs/kg. In addition this system can learn different load cell ID codes and then keep a log for a period of time such as the last 12 hours or last 30 days. There can also be alarms such as a low battery alarm in either the control module or in the load cell modules and a loss of communications alarm as well.

With this design, the control module can include a housing or an enclosure, a power supply such as a battery or a DC power adapter. There can also be a multiple button or keypad overlay which overlays the electronics of the device. These electronic components can include a plurality of power supply circuits, a microcontroller, an EEPROM or memory unit, an LCD display, 7 push button inputs, a UHF ASK radio receiver, an IrDA transceiver or bluetooth transceiver, and connectors. The load cell can include an enclosure, a 2 layer PCB board, a set of power supply circuits, a microcontroller with UHF ASK radio transmitter; a set of battery monitor circuits, a push button input, and connectors.

With these embodiments, the controller program on the control module receives the 4 weight measurements from the load cell boards and then combines these values to determine the total weight for the bed. If set, the zero point value for the bed is subtracted from this number to give the total weight less the weight of the bed. If this is not set then the total weight of the bed with the additional weight is indicated. The user can also review more than one bed at a time using this remote control unit so that a display will display not only the readout of the four weight measurements or the combined total for one bed but also the separate measurements for different beds within range while still identifying these different beds.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of the system including an air mattress;

FIG. 2 is a front view of the central housing revealing the components disposed in the central housing;

FIG. 3A is a side view of a remote scale; and

FIG. 3B is a top view of the remote scale shown in FIG. 3A.

FIG. 4 is a schematic block diagram of another control board not using the pump shown in FIG. 2;

FIG. 5 is a schematic block diagram of another load cell;

FIG. 6 is the top perspective view of the load cell shown in a schematic block diagram in FIG. 5;

FIG. 7A is a top view of the embodiment shown in FIG. 6;

FIG. 7B is a side view of the embodiment shown in FIG. 7A;

FIG. 7C is another side view of the embodiment shown in FIG. 7A;

FIG. 7D is a perspective view of a wheel loaded on the load cell shown in FIG. 7A;

FIG. 8 is a side view of a load block shown in FIG. 6;

FIG. 9 is a flow chart for the process for evaluating a bed weight.

### DETAILED DESCRIPTION OF PREFERRED EMBODIMENTS

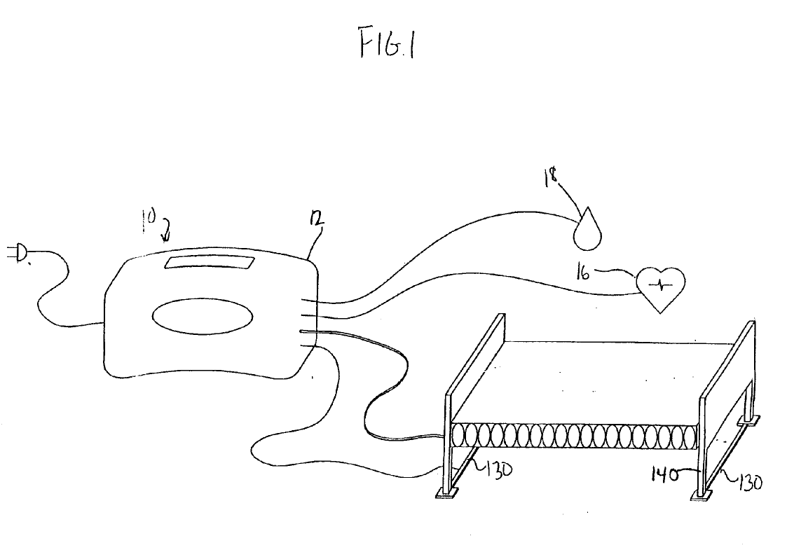

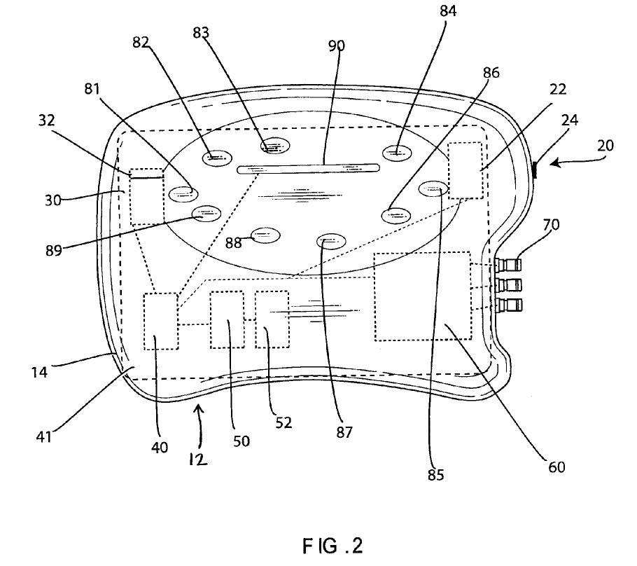

Turning now in detail to the drawings, FIG. 1 shows an overview of a patient management system 10. This patient management system 10 includes a central patient measurement device 12 including a central housing 14 (See FIG. 2). This central patient measurement device can include a communication element 20 (See FIG. 2) for wired or wireless communication with adjacent remote components. This communication element may contain a wireless transceiver 22 or a hard wired ethernet connection 24 for connecting an ethernet cable to housing 14. In addition, coupled to housing 14 can be additional patient monitoring devices such as a blood pressure monitor 16 or a temperature monitor 18. Temperature monitor 18 can be in the form of a strap on thermometer via a pad incorporated into a bed or via any other known thermometer or temperature taking device. Other known thermometer devices are known in the art such as in U.S. Pat. No. 6,454,724 incorporated herein by reference. Additional measuring devices may be coupled to housing 14 and in communication with the patient measuring device as well.

FIG. 2 shows the device 12, which has numerous components stored inside of a housing 14. Housing 14 can be made from any durable or semi-durable material such as steel, aluminum or plastic. In this case, these components include a power source 30 which can include a battery 32, a processor 40, a memory 50, an optional second memory 52, and a pump 60 all of these components can be coupled together via a main board 41. In addition, coupled to this housing are valves 70 which can be used for fluid intake and for fluid outflow wherein the fluid can be for example, air. A timer 76 is disposed in housing 14 and can be used to regulate particular processes such as a time for reading a weight of a user or a time for starting pump 60. Disposed on an external surface of the pump is a set of keys or buttons 80 for receiving information from a user and also a display 90 for displaying information. Display 90 can be in the form of a 16 character dot matrix LCD display which can be used to display either pounds (LBS) or kilograms (KG).

With this design, power source 30 can include an outlet or plug to an external power source such as a wall outlet producing 110 or 220 VAC at approximately 50-60 Hz. Other known power sources can also be used as well. In addition, this power source 30 is in electrical communication with battery 32 and can be used to recharge a battery 32. Power source 30 is used to power the remaining components in the housing.

Processor 40 is in communication with, and can be used to control the remaining components in housing 14. For example, processor 40 receives instructions from a memory 50 and also input keys 80 wherein this processor processes these instructions to perform particular tasks such as instructing pump 60 to pump additional fluid into a remote compartment such as an air bed.

In addition, processor 40 can also process any information received from communication device 20, to create a readout on display 90 to instruct users on a patient's weight or other vital statistics.

Device 12 can be in communication via communication device 20 with a remote scale 130, (See FIG. 1) which in this embodiment is in the form of a bar which stretches across two legs of a bed 140. In this case, this remote scale can be used to measure the weight of a bed and also the weight of a user on a bed. To determine the weight of a user on a bed, the scale can first be calibrated to determine the weight of the bed. The information on the weight of bed 140 is received by communication device 20 either through wired communication through communication port 24 or through wireless communication through wireless transceiver 22. This information is next processed by processor 40 and then the resulting weight is displayed on display 90. This wireless transceiver 22 can be in the form of a radio frequency transceiver or via a bluetooth transceiver.

Once the weight of the bed has been determined, the weight scale can be synchronized to zero out, to create an effective weight of zero. A zero key 82 can thereby be pressed to zero out the total weight calculated to this point. Thus, when a user is on a bed, only his or her own weight is registered into the scale and then viewed on the readout. This device can also be used to determine a users vital statistics such as temperature or blood pressure. For example, there is a temperature button 81 and a blood pressure button 83. When a user takes a patient's temperature and presses temperature button 81, display 90 then reads the temperature of the patient. In addition, when a user takes a blood pressure reading of a patient, and presses blood pressure button 83 display 90 would then render a blood pressure reading for the user as well.

Next, as the user is placed on the bed, the total weight is determined at this new zeroed out setting to determine the weight of the user.

This device 12 can also be used to determine the effective force or weight on multiple different scales and then either average this weight to arrive at an overall weight or report on each individual weight as well. Thus, there is a cycle weight button 84 which can be used to allow a user to cycle through various weights for a user such as an overall average weight or a weight for each one of the scales. In addition, there is an auto zero button 85 which allows the user to zero the scale. Furthermore, there is also a hold or freeze/resume button 86 which can be used to freeze and store any displayed weight. In this case, the stored weight can be stored in memory 50 or in additional memory 52. This freeze/resume button 86 allows the user to freeze the patients weight in the readout and then make any subsequent changes to an adjacent bed before resuming measurements.

A weight recall button 87 can also be used to display on display 90 a last known or recorded weight. This information may be stored in memory 50 or additional memory unit 52. A weight change button 88 can also be used to present to a user the difference in weight of a patient across a control group. In this case, a user can set an initial weight so that a subsequent weight change can be recorded or, processor 40 and memory 50 can record a weight change across a period of time such as a day, a week, a month or a year. Finally, a weight toggle button 89 can be used to toggle between pounds and kg in the readout of display 90.

Memory unit 50 and memory unit 52 can be in the form of a flash memory, a form of random access memory or RAM, or any other memory unit known in the art. These memory units can hold their memory even if power is lost. This device can operate with one single memory unit 50 or with an additional memory unit 52. In one embodiment, memory unit 50 can be used to store a set of instructions, operating system or program to control processor 40 and the remaining components. Additional memory unit 52 can therefore be used to store a patient's information or vital statistics such as weight, blood pressure, respiratory results, temperature etc.

With these buttons, it is possible to easily move a bed and a patient without losing the settings of a patient. In this case, before moving the bed or the patient, the user can press the hold or freeze/resume button wherein display 90 will read “freeze”. Next, the user can make any necessary adjustments to the bed or patient such as moving the bed. Once the patient has been resettled, the user can then press the freeze/resume button again and resume normal weight monitoring.

If there is a loss of power, or if it is necessary to disconnect the bed power when the scale is in use, the user can press the freeze/ resume button 86 and then resume the use of this device.

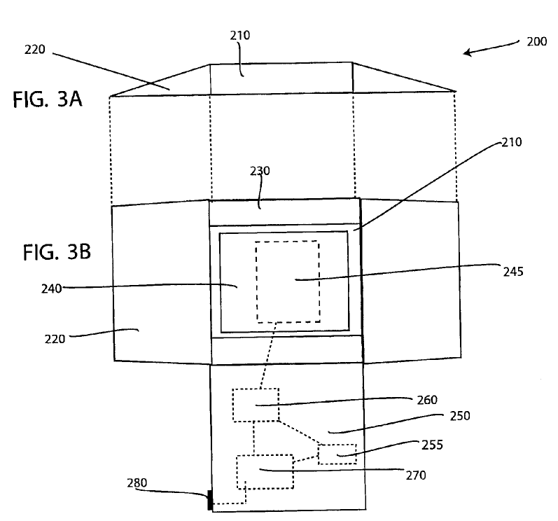

FIG. 3A shows a side view of a remote scale 200 which can include a central housing 210, which has ramps 220 disposed on either side. FIG. 3B shows a top view of this device wherein this device includes lateral supports 230 to support a wheel, a bed leg or other similar type device on a pressure plate 240. These lateral supports are raised up above housing 210 to keep a wheel from rolling off. Plate 240 is disposed in housing 210 and is adjacent to, or on top of sensor 245. Sensor 245 can be in the form of a transducer such as a piezoelectric sensor. In addition, there is an adjacent housing 250, coupled to and disposed adjacent to housing 245. Disposed in adjacent housing 250 is a power supply such as a battery 255, a processor 260, to receive and process signals from sensor 245. These signals are then transmitted to an associated patient management system 10. Adjacent housing 250 can also include an additional or alternative communication connection 280 which can be in the form of an ethernet connection for communication via wires to hard wired ethernet connection 24.

With this design, a user can place one or more of these remote scales 200 in a position adjacent to a bed. In many cases, the bed can be transportable on wheels. This bed can then be rolled up on ramps 220 so that wheels on the bottom of a bed frame rest on impression or pressure plate 240. The weight of this bed then presses down on pressure plate 240 to provide a pressure on sensor 245. The signals based on the weight pressure on sensor 245 are then transmitted to processor 260 wherein these signals are then transformed into communicatable signals via wireless transmitter/ transceiver 270 or through wired ethernet connection 280. The wireless transmitter/transceiver 270 can be in the form of a radio frequency transceiver or via bluetooth or any other known transmission method.

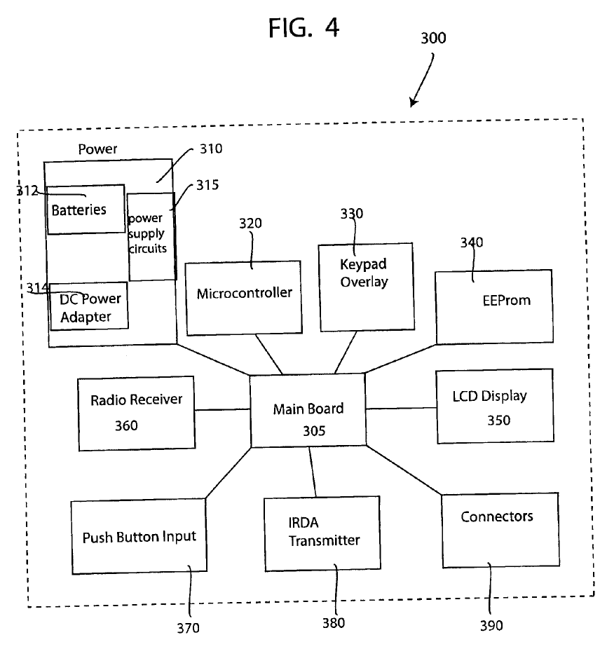

FIG. 4 is a schematic block diagram of another embodiment of a control unit wherein this control unit 300 is not in the form of a pump. Instead this control unit is used to communicate with other devices and can then relay this information to a pump. In this case, there is a power supply unit 310 which can be in the form of a DC power adapter 314 and/or a set of batteries 312. The DC power adapter can be in the form of a transformer that is used to provide 7V DC to the control module. The adapter can be a medical power adapter with a.1″ coaxial plug that is center positive. The batteries 312 can be in the form of three AA rechargeable batteries that can be used to supply the control board with a supply voltage of 4.5 V DC. Then a National Semiconductor® LM2621 DC-DC step up converter can be used to step up the battery voltage to 7 VDC. These batteries can be trickle charged when the adapter is plugged in.

The main board 305 can be in the form of a FR4 two layer board wherein all the components inside of the enclosure are mounted on the board.

Power supply circuits 315 can be used to convert the unregulated 7 VDC to provide a regulated 5 VDC for the devices on board.

The microcontroller 320 can be in the form of an 8 bit microcontroller which can have 32K bytes of flash memory 1024 bytes of ram 6 general purpose I/O ports, a true watchdog timer circuit, low voltage detection circuits, a real time clock, and in circuit programmability. The microprocessor is clocked at 4 MHz using an external 8 MHz crystal connected to the internal oscillator.

The watch dog timer (WDT), and the low voltage detector are used to ensure the proper operation of the microcontroller. The firmware strobes the watchdog timer at regular intervals. In this case, if an interval is missed or the watch dog timer is not strobed, the microcontroller is reset if the voltage drops below 4 vDC.

The microcontroller on chip real time clock is used to provide the date and time for storing the weight measurements. The microcontroller can include 6 general purpose I/O ports with a first port for connecting to and receiving data from the RFASK data, the IrDA control lines and from the EEPROM serial interface.

The second port is a general purpose I/O port which can be used to couple to the LCD display.

The next I/O port is also for the LCD wherein it can provide the upper 4 bits of the LCD data bus, the LCD backlight control, and has some pins for the background debug and programming interface.

The next I/O port is a 6 bit general purpose I/O port which can be configured to provide the lower 4 bits of the LCD display data bus.

The next port is a 2 bit general purpose I/O port. In this case, the port is not generally used.

The final port is for receiving the input from the 6 push buttons.

The EEPROM 340 can be in the form of a Atmel® AT24C08 1024×8 bit serial EEPROM that can be used to provide nonvolatile memory to store data for bed configurations.

The LCD display can be an AZ Displays ACM1602B LCD display that can be used for the control board. It can be in the form of a 2 line by 16 character display with an LED back light.

The LCD display 330 is controlled by the microcontroller using an 8 bit parallel interface.

In this case, the LCD back light is controlled by an output from the microcontroller wherein this back light is turned on by the software for 30 seconds when any key is pressed.

The push button inputs can be in the form of a seven switch set of push buttons that can be used for the keypad buttons. The buttons can be used for the following purposes: to zero the current weight display; to switch between pounds and kilograms displayed on the weight; a freeze/resume button that freezes the displayed weight at the current value; a mode button that selects the menu to display settings, bed number, and the previous weight measurements; an up button to scroll up through menus; a down button to scroll down through menus, and a select button which can be used to select menu items or sub menus.

The radio receiver chip can be used to implement a low cost short range single frequency super-heterodyne receiver. In one example, it can be in the form of a UHF rfRXD0420 UHF receiver that can be configured for a single channel at a fixed frequency of 433.92 MHz using an amplitude shift Keying (ASK) modulation, at a signal rate of 2400 baud.

In this case the receive frequency can be set by the crystal frequency and the intermediate frequency.

A 26.45125 MHz crystal can be used to set to clock on the receiver. A 10.7 MHz ceramic filter with a 280 kHz bandwidth can be used for the intermediate frequency filter. In this case, the antenna can be created using a small wire soldered onto the PCB. In addition a SAW filter can be used to filter out the RF image frequency and to filter a wide band noise and to improve the signal to noise ratio or SNR of the antenna.

The IrDA transceiver 380 can be in the form of an encoder/decoder which can include a microchip MCP2150, a IrDA transceiver in the form of a Vishay TFDU4100, which can be used to provide an IrDA communication circuit for the control board. In this case, the encoder/decoder can support the IrDA with an IrCOMM 9 wire cooked service protocol. The communication can be fixed at 9600 bps. Alternatively, instead of using an IrDA transceiver, a bluetooth transceiver can be used to communication with other units such as a computer, a PDA or other remote devices.

Additional connectors 390 can be included in the main board 305 including a power supply connector and a LCD connector which can be used to control LCD display 350. There can also be a background debug programming connector which can be used to provide an interface for a background debugger and programmer.

With the case of another load cell module 400 which is a different embodiment than that shown in FIGS. 3A and 3B, this module is shown by way of example in the block diagram, this load cell module can include a main board 405, a power supply 410, including batteries 412, a battery monitor 420, a push button interface 430, a microcontroller, connectors 450 and a load cell interface 460 all coupled to main board 405.

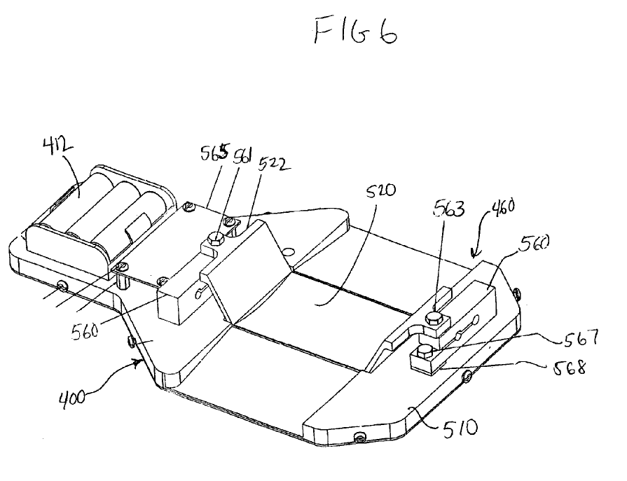

In this case, embodiments of this load cell can be shown in FIGS. 6, 7, and 8.

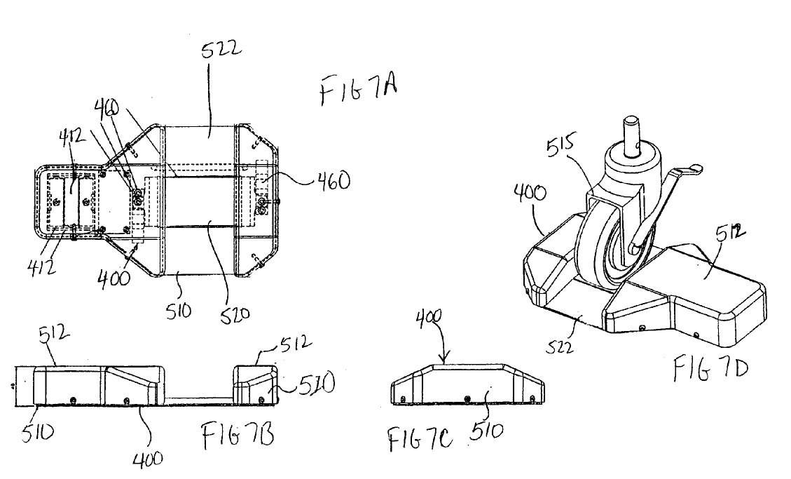

The load cell 400 shown in FIGS. 6 and 7, can be formed from a metal base 510 and a plastic cover 512. The metal base can be machined to allow a bed wheel 515 to roll on to it. The plastic cover 512 is custom fit over the metal base and to cover the load cells and cover the batteries and load cell transmitter board. This plastic case or cover 512 is designed to allow the battery to be changed by opening the back of the enclosure.

In this case, for power, the power supply 410 can include three AA batteries 412 which may be used, wherein these batteries may be used and then the voltage from these batteries could be regulated using a linear regulator. Battery monitor circuits 420 can be used to provide a reading of the battery voltage. The output of the divider can be connected to the second input channel of the A/D converter 466.

The push button inputs 430 can be in the form of a Panasonic EVQ-PBC07K push button switch that can be used to indicate to the microcontroller that it is to transmit the identification code for this load cell module. This identification code is transmitted so that the control module can learn the identification codes of the 4 load cell units that will make up a complete system.

The microcontroller 440, can, in one example, be in the form of a Microchip rfPIC12F675 Flash based microcontroller. This device can include 1024 words of Flash program memory, 64 bytes of RAM, 128 bytes of EEPROM, 6 general purpose I/O pins, a 4 channel 10 bit A/D converter, a SLEEP mode low power operation, a watch dog timer, brown out detection circuits, and an integrated UHF ASK radio transmitter.

The microcontroller 440 can support in circuit serial programming so that the board can be reprogrammed with the microcontroller instead. This microcontroller can be clocked at 4 MHz using the internal 4 MHz oscillator.

The integrated UHF Radio transmitter can be used to implement a short range frequency transmitter. The transmitter is configured for a single channel at a fixed frequency of for example 433.92 Mhz using amplitude Shift Keying modulation at a signal rate of 2400 baud. The transmit frequency can be set using an external crystal oscillator. For example, a 13.56 MHz crystal can be used to clock the receiver. The antenna can be created using a small wire loop on the main board. This transmitter can be turned off when not in use. While one transmitter has been shown, other transmitters may be used such as a bluetooth transmitter as well.

The load cells 460 can be in the form of two load cells which each provide one half of a Wheatstone bridge. These load cells are connected together to provide a full bridge. This bridge has a maximum span of 12 mV. Coupled to these load cells are load excitation circuits 462 wherein these load cells are energized using 3 VDc and −3 VDC supplies.

The signals from the load cells 460 can be sent from the pressure sensor bridge to an amplifier 464 which can provide a gain on the reading. In one example, the amplifier can be in the form of a Texas Instruments® INA 118U precision, low power instrumentation amplifier. The amplifier is configured to provide a gain of 102. The gain is established using a 0.1% resistor with a temperature drift of 25 ppm.

The amplifier 464 can be coupled to an analog to digital converter 466. This A/D converter can be in the form of a Analog Devices® AD7705BR 16 bit Sigma Delta Analog to Digital converter. The A/D converter is operated with an internal gain of 1 and a conversion rate of 60 Hz. A clock frequency of 2.4576 MHz is used to drive the A/D converter. This results in a −3 db frequency of 15.72 Hz and a sampling rate of approximately 38.4 KHz.

A conversion reference voltage is generated using a resistor divider network across a bridge excitation voltage. The reference voltage can be set to 1.25 VDC.

In this case, an active region of the load cell can be 0 to 12 mV corresponding to a load between 0 and 220.5 lbs. The active region will be resolved to 0.183 uV corresponding to an accuracy of 0.003 lbs. The estimated error over a 6 hour period assuming a maximum load of 220.5 lbs and a maximum temperature range of 2.5 degrees Celsius is 0.1 lbs per load cell. Thus, for four load cell systems, the total error is estimated to be 0.4 lbs assuming a worst case scenario where all the load cells drift in the same direction.

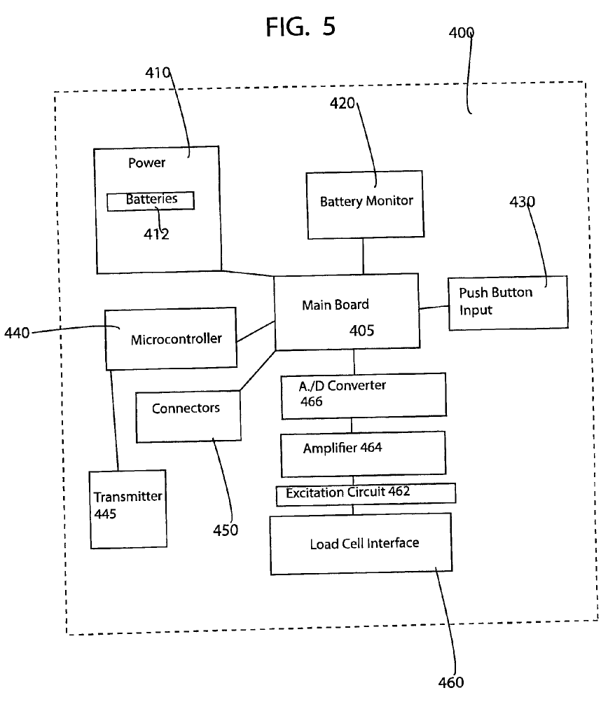

FIG. 6 shows a perspective view of the device shown in a schematic block diagram in FIG. 5. In this case there is the load cell 400 which can include a power input in the form of batteries 412, a set of load blocks 560, a housing 510, a cover (SEE FIG. 7A) and a load plate 520. Load plate 520 can be in the form of a curved or concave load plate 520 which can be used to support a wheel inside to keep it from moving. Load plate 520 has side walls 522 and can be coupled to load blocks 560 via screws 561 and 563. Load blocks 560 are coupled to base plate 510 via screws 567 and rest on top of pads 568. FIGS. 7A, 7B and 7C show the top and two side views of this device as well and also show the presence of cover 512 which can snap over base 510. There is also a support plate 565 which is disposed between load cell 560 and batteries 412.

FIG. 7D shows a load wheel 515 which can be placed on top of this device to load the load plate. When this occurs, the load on load plate 520 creates a rotating or bending moment of load blocks 560, thus creating a strain force which can be read into the system shown in FIG. 5 such as into the load cell excitation circuit 462.

The load cell block 560 can be in the form of different components including a base body 570, a first section 572, a second section 574 and holes 576 and 578. This design is set to allow a moment force on load cell block 560 to create a reading which can be used to determine the load pressure on load plate 520.

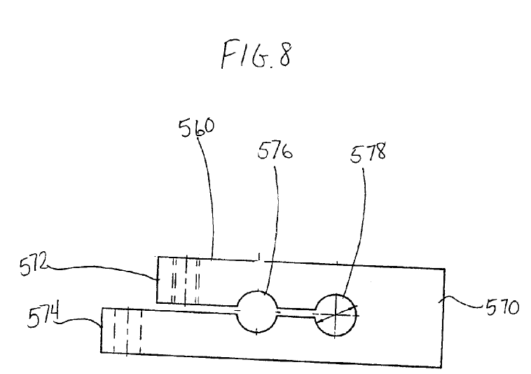

FIG. 8 shows a side view of a load cell block which can be used with a strain gauge. With this design, the load cell block 560 can include a main body 570, a first leg 572, a base leg 574 and two holes 576 and 578. These holes can serve as select strain points when the load block is loaded. Coupled to this load cell block is a strain gauge system which can include a resistor which is coupled to this block to provide a resistance readout to indicate a load on this block. The readout from these blocks can then be used to provide a total load on the load plate for an individual load cell 400.

The load cell can operate as follows, the controller can receive a message from a transmitter board within two minute intervals. If a message is not received within a 2 minute interval then the controller will display a loss of a communications message. The main controller 300 also monitors the battery status of each load cell. If a load cell monitor indicates a low battery in the message then the controller will display a low battery warning.

This controller board program can retrieve four weight measurements from the load cell boards and combines these values to determine the total weight for the bed. If set, the zero point value for the bed is subtracted from this number to give the total weight less the weight of the bed. If it is not set, then the total weight including the bed is displayed.

The load cell module can operate in at least two modes, a normal mode and a sleep mode. When in the normal mode, the load cell can read weight readings into the A/D converter 466 and then transmitted to the control module 300 via transmitter 445.

A timer can be associated with microcontroller 440 which can then be used to turn off the load cell after a period of time when not in use. At this point the load cell 400 will be in a sleep mode.

The counter associated with microcontroller 440 can be used to keep track of the number of times the unit has woken up from sleep. When the counter has expired, the unit will scan the push buttons to check the format of the timer.

The data that is transmitted to the control module using the RF transmitter 445 that is integrated in the microcontroller 440. The message is transmitted three times before the transmitter is turned off.

The reading in the control module is one of the load cell and battery readings which includes a 16 bit voltage level read from the sigma-delta A/D converter. The control module 300 then converts these values into a weight and battery voltage.

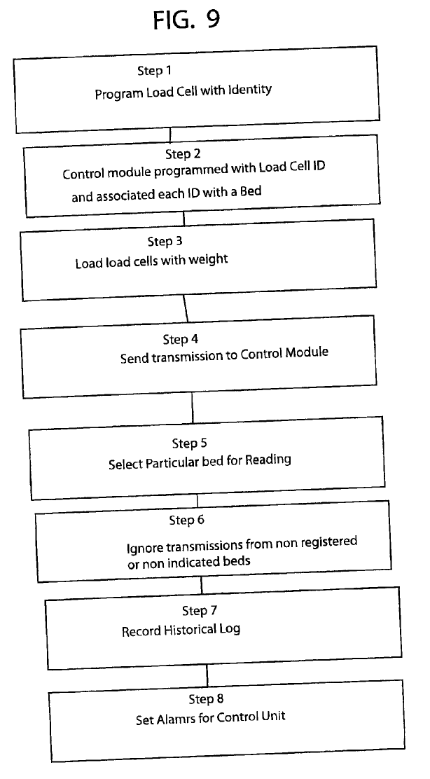

The controller is designed to only read particular load cells at a particular time. For example, each load cell will be identified with an ID code, wherein the control module can be programmed to associate four load cell ID codes with a single bed, the controller will ignore ID codes that are not associated with a single bed, the load cell will transmit messages at random intervals so that repeated collisions will be unlikely. As shown in FIG. 9 this process for programming and using the control module is as follows:

In step 1, each load cell 400 is programmed with an identity. Next, in step 2 the control module is programmed with the identity of each load cell and up to four load cells are associated with a bed. For example, when programming, the control module, the load cells can be set in a specific order such as right head bed leg and denoted as (RH) in the display, left head bed leg (LH); right foot bed leg (RF) and left foot bed leg (LF). For reading a normal four leg bed, these designations in the are already set so that it is easy to match these designations with the preset conditions in control module 300. In step 3, a set of load cells are loaded with a weight such as four separate load cells sitting under four posts for a bed. Next, this information is transmitted to a remote control module 300. As shown in step 4, this transmission will occur repeatedly at random intervals so that collisions are unlikely. The transmission interval can range anywhere from 20 to 38 seconds.

At this time, as shown in step 5, a user can select a particular bed scroll and select that bed for reading this transmission. By selecting a particular bed, this control module as shown in step 6 can ignore any transmissions from any load modules 400 which are not associated with a particular bed. As shown in step 7, a user can record or scroll through a historical log of different readings for each bed, wherein these readings are sorted by bed identification, and reading time and date. For each reading the user can select the time including hours, minutes, seconds, AM/PM by scrolling through a menu. This information can then be stored in either a 24 hour log or in a 30 day log for future viewing. Step 8 also indicates that alarms can be set and for indicating whether there is any reading from a transmitter board associated with a load cell. The alarms will indicate whether there is a loss of transmission from any one of the load cells or whether there is a low battery in any one of the load cells. If there is a low battery in a load cell, no communication from a load cell, or the control unit has a low battery, the historical logs which may be a 24 hour log or a 30 day log will not be updated with information. The historical logging will resume when all errors have been cleared.

Accordingly, while a few embodiments of the present invention have been shown and described, it is to be understood that many changes and modifications may be made thereunto without departing from the spirit and scope of the invention as defined in the appended claims.

What is claimed is:

1. A portable patient management system which can be used to monitor the particular health characteristics of a patient comprising:
a) a central housing;
b) a pump disposed in said central housing;
c) at least one display disposed in said central housing;
d) at least one processor disposed in said central housing said processor in communication with said pump and said display;
e) at least one memory unit disposed in said central housing for containing a plurality of instructions to control said processor;
f) at least one communication element disposed in said central housing; and
g) at least one remote scale, having a housing and a remote communication element stored in said housing, said remote communication element for communicating with said at least one communication element, to transmit a weight measurement to said processor in said central housing.

2. The system as in claim 1, wherein said at least one remote scale has a sensor, and wherein said housing on said at least one remote scale includes at least one ramp, and at least one impression plate disposed in said housing adjacent to said ramp, said impression plate for allowing a device having a weight to press against said sensor.

3. The system as in claim 1, wherein said sensor is a transducer.

4. The system as in claim 1, wherein said sensor is a piezoelectric sensor.

5. The system as in claim 1, wherein said sensor is in the form of a leaf spring which when flexed provides a measurement for a weight of an element to be weighed.

6. The system as in claim 1, wherein said housing for said remote scale includes a lateral stabilizer for laterally stabilizing a device to be weighed.

7. The system as in claim 1, wherein said at least one remote scale further comprises a power unit disposed in said housing adjacent to said impression plate for providing power to said scale.

8. The system as in claim 2, wherein said sensor is disposed adjacent to said impression plate.

9. The system as in claim 8, wherein said sensor can be depressed by said impression plate when an object is placed on said impression plate.

10. The system as in claim 1, wherein said at least one communication element in said central housing includes a jack and wherein said communication element in said housing for said at least one remote scale includes a jack.

11. The system as in claim 10, wherein said at least one communication element is in the form of an ethernet connection.

12. The system as in claim 1, wherein said at least one communication element is in the form of a wireless communication element having a wireless transponder.

13. The system as in claim 12, wherein said at least one communication element for said at least one remote sensor is in the form of a wireless communication element having a wireless transponder.

14. The system as in claim 1, further comprising a pressure measuring device disposed in said central housing for measuring a gas pressure of an adjacent compartment.

15. The system as in claim 14, wherein said adjacent compartment is in the form of an air filled mattress.

16. The system as in claim 15, further comprising a conduit for fluid communication between said pressure measuring device and said adjacent compartment.

17. A portable patient management system which can be used to monitor the particular health characteristics of a patient comprising:
a) a central housing;
b) a pump disposed in said central housing;
c) at least one display disposed in said central housing;
d) at least one processor disposed in said central housing said processor in communication with said pump and said display;
e) at least one memory unit disposed in said central housing for containing a plurality of instructions to control said processor;
f) at least one wireless communication element disposed in said central housing;
g) pressure measuring device disposed in said central housing for measuring a gas pressure of an adjacent compartment;
h) at least one remote scale, having a housing and a remote wireless communication element disposed in said housing, said wireless remote communication element for communicating with said at least one wireless communication element, to transmit a weight measurement to said at least one central measurement device wherein said memory includes a plurality of instructions to control said processor and said pump to adjust a preset pressure range based upon a weight measurement in said at least one processor in said central housing.

18. A wireless weight scale system comprising:
a) a plurality of load cells having at least one wireless transmitter;
b) a central control module having at least one receiver for reading information form at least one load cell wherein the central control module sums up the total weight from each of the load cells;
c) a display in communication with said central control module for displaying a reading for the total weight from each of the load cells; and
d) a transmitter coupled to said central control module, wherein said transmitter can then relay this information to another device for storage of each reading.

19. The device as in claim 18, wherein said transmitter is in the form of a wireless transmitter.
